(19) United States
(12) Patent Application Publication
(10) Pub. No.: US 2009/0268627 A1
(43) Pub. Date: Oct. 29, 2009

(54) METHOD FOR RING MANAGEMENT IN AN ETHERNET NETWORK COMPRISING A PLURALITY OF REDUNDANCY MANAGERS

(75) Inventor: Pedro Ricardo de Frias Rebelo Nunes, Linda-A-Velha (PT)

Correspondence Address: K&L Gates LLP, P.O. BOX 1135, CHICAGO, IL, 60690, US

(73) Assignee: Nokia Siemens Networks GmbH & Co. KG, Munchen (DE)

(21) Appl. No.: 12/299,686

(22) PCT Filed: Apr. 30, 2007
(86) PCT No.: PCT/EP2007/054209

§ 371 Date: Jul. 13, 2009

(30) Foreign Application Priority Data
May 5, 2006 (EP) 06009377.0

(51) Int. Cl. H04L 12/26

(52) U.S. Cl. 370/252

(57) ABSTRACT

Test packets (TP1, TP2) are emitted from redundancy managers (RM1, RM2) containing a source address and a rank number (RN) in information fields. Another redundancy manager (RM1) replaces this rank number only if its own rank number is lower (higher priority) than the rank number in a received test packet. All redundancy managers (RM2) with a higher rank number switch to a passive mode and only the redundancy managers (RM1) with the lowest rank number remains active.

### CLAIM FOR PRIORITY

This application is a national stage application of PCT/EP2007/054209, filed Apr. 30, 2007, which claims the benefit of priority to European Application No. 06009377.0, filed May 5, 2006, the contents of which hereby incorporated by reference.

### TECHNICAL FIELD OF THE INVENTION

The invention relates to a method for ring management in an Ethernet network.

### BACKGROUND OF THE INVENTION

The principle of Ethernet ring protection mechanism ERP is described, for example, in U.S. Pat. 6,430,151. It relies on a ring or redundancy manager RM associated to a node to coordinate protection activities. An essential feature of the Ethernet is to avoid a loop. When a redundancy manager node (referred to as RM—redundancy manager) perceives that the ring is healthy, i.e. all nodes and links are functioning, it blocks one of its ports for reception und transmission of normal data traffic to interrupt a physical loop. All traffic is blocked for that port except for Ethernet ring protection control traffic, such as test packets. These “test packets” are frequently transmitted from both ports (terminals) of the RMs .

If by mistake or malfunction two or more ring nodes are configured to take the RM role, this could lead to undesired effects as permanent segmentation of the ring or permanent loop configuration.

The ring segmentation happens because all RMs transmit test packets and all RMs receive test packets. So each RM assumes that the ring is operational and blocks one of its ring ports to break the loop, with the result that some nodes become unreachable. Because the blocking of the data traffic has no effect for the transmission of test packets, all RMs receive test packets further on and maintain blocking one of their ring ports.

The second case may happen if the RMs do not forward or accept each others test packets. Each RM assumes that the ring is damaged and will unblock its ports. This results in a loop formation and to circulating data frames blocking all data traffic.

### SUMMARY OF THE INVENTION

In the invention, one active redundancy manager RM is allowed in a ring. Therefore, a rank number is dedicated to each RM, and each RM sends information packets, referred to as “test packets” (these could be any kind of packets) with its rank number to all other RMs. All RMs with higher rank numbers (lower priority) (or, by definition, lower rank numbers) switch into a passive mode according to a selection process. Each RM evaluates its own “test packet”—initiated and emitted by itself and forwarded over the ring by all other nodes/RMs. Depending on the information about the other RMs added to the test packet, the RM switches to a passive mode and becomes a passive RM or remains active. The active RM with the lowest (or, by definition, highest) rank number remains active. The whole process is independent of the management system.

After all RMs, with one exception, have switched to the passive mode, the only active RM still blocks one of its ports continuously for regular traffic and starts the Ethernet Ring Protection process ERP in due time.

A similar process selects a passive redundancy manager with the lowest rank number (highest priority) to become an active RM.

### BRIEF DESCRIPTION OF THE DRAWINGS

The invention is described with reference to the accompanying drawings and exemplary embodiments, which will become more apparent with reference to the following description, in which

FIG. 1 shows an Ethernet ring in a normal state.

FIG. 2 shows an Ethernet ring with two active redundancy manager, each blocking one of its ports.

FIG. 3 shows an Ethernet ring with two redundancy manager unblocking their ports.

FIG. 4 shows a flow chart for disabling/enabling a redundancy manager.

FIG. 5 shows a simplified flow chart.

FIG. 6 shows a flow chart for disabling/enabling a redundancy manager for larger systems.

### DETAILED DESCRIPTION OF THE INVENTION

FIG. 1 shows an Ethernet ring with nodes A-E and G in normal state. The node G is activated as redundancy manager RM1 and blocks one of its ports for data traffic to interrupt the ring. A management system MS is connected with the ring over a further node F.

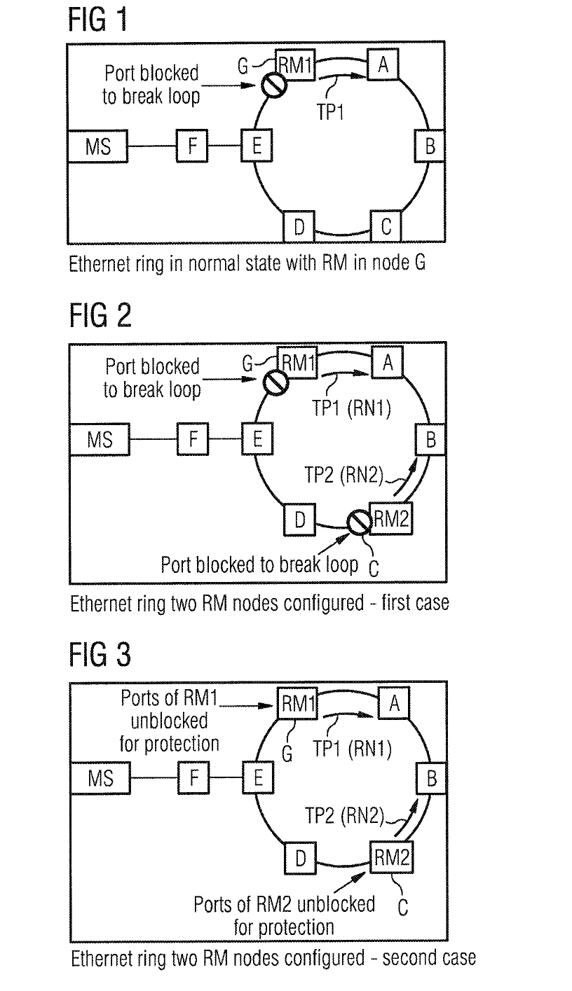

FIG. 2 shows an Ethernet ring with two active redundancy managers RM1 in node G and RM2 in node C. The ring can be a part of a larger network. Both RMs have transmitted test packets (control packets) TP1 and TP2 respectively and had come to the conclusion that the ring is working because they forwarded or accepted the test packets of the other RM. Each RM has blocked one of its ports for data traffic, so the nodes E and D cannot be reached any more. If both RMs do not accept each others test packets they may come to the conclusion that the ring is permanently damaged. Each RM unblocks its previously blocked port with the result that a loop is arranged leading to circulating frames in the loop according to FIG. 3—until the ring is blocked again.

The invention is based on at least the fact that:
1. Detection that there are more than one active redundancy managers RMs in the ring,
2. The RMs in a ring select a self-depending one of the RMs to be the only active RM to guarantee functionality in the ring and to unblock its port, and
3. All remaining RM nodes, the “disabled/not selected” or “passive” RM nodes unblock their ports for traffic. They forward modified test packets from other RMs until the test packets reach the (e.g. active) RM, who initiated the test packet. Each RM evaluates only its own test packet for changing its mode between “active” and “passive” and does not forward it. The detection and selection of an “active RM” is based on test packets. A selection criteria is a minimum or maximum selection of an address or a “rank number”, e.g. generated randomly or according to traffic requirements or assigned to the RMs by the management system MS. For example, the address can also be used as the “rank number.” A “minimum rank number” (highest priority) is used in the description and the claims as an example but could be exchanged with a “maximum rank number” or “extreme rank number” (highest priority).

The modified test packets TP1 which is sent by a first redundancy manager RM1, includes (among other information) the source address “SOURCE” (of the first RM1) in an address field AF and the rank number RN1 in a rank number field RF, which can be used from all other RMs in the ring to inform the first RM1 about the rank number (and the status) of any other RM in the ring, when this is relevant for the selection process.

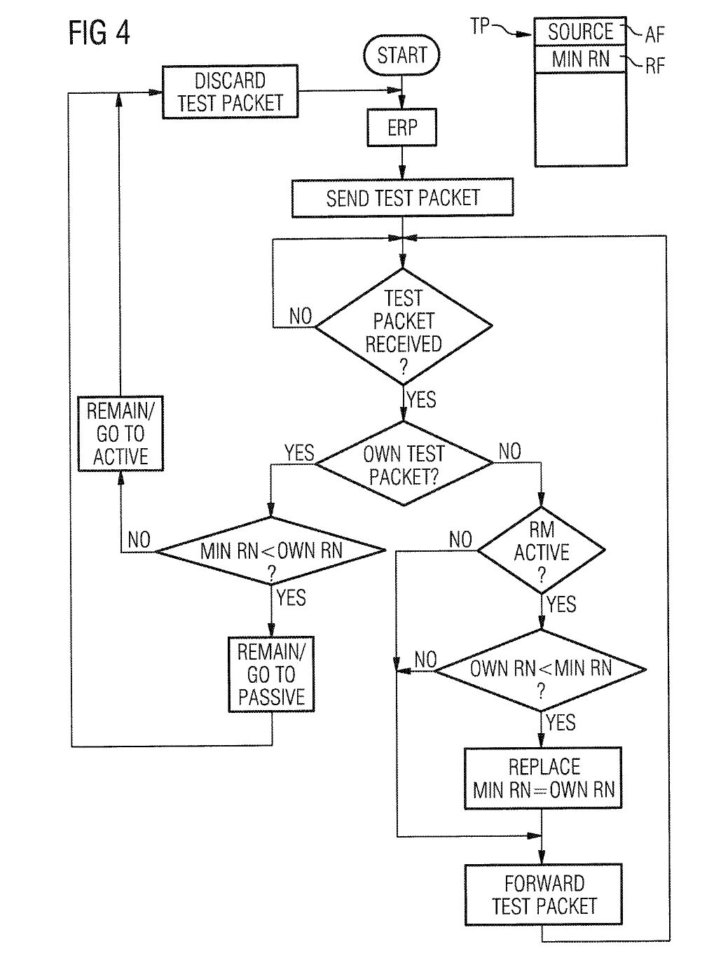

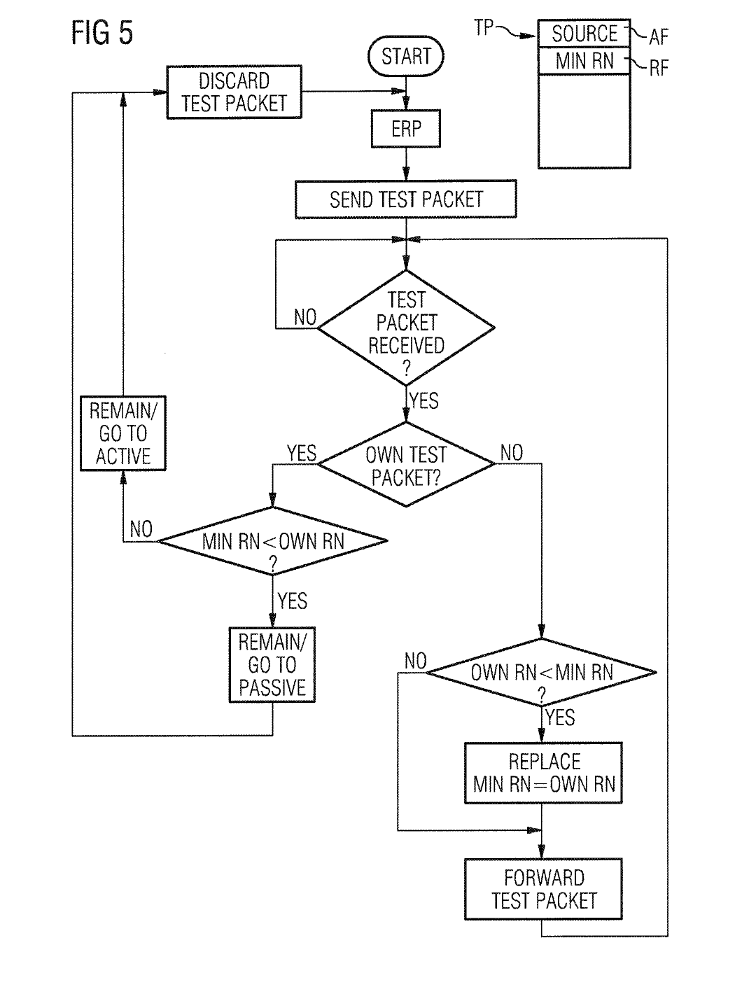

If two or more RMs are active, the RM1 with the lowest rank number RN=1 (highest priority) should be elected as “active RM” and all others are switched to the passive mode. Assuming a simplified flow chart shown in FIG. 4, and a simplified ring with only two RMs according to an ERP-process (Ethernet ring protection), the selection process starts in a simplified ring with only two RMs by transmitting test packets from each RM1 and RM2. Of course, there are several possibilities to implement the process, as described below.

In one embodiment, the active first RM1 sends its own “test packet” TP1 according to the test packet TP shown in FIG. 1, which includes a source address, e.g. “SOURCE=1”, and the rank number RN1=1 (FIG. 1) of the RM1. The source address can also be used as the rank number (in this case the rank number field RF can be left empty). In the examples, the RM1, initializing a test packet, inserts its source address in the address field and its rank number RN1 as Min RN in the RF field. If the source address and the rank number are used, the rank number can be changed independent from the source number.

All other RMs in the ring check the received test packet, which is initiated by RM1. If a TP is received from a passive RM or a node without RM-Function, the test packet TP1 is forwarded unchanged until it is received from the second active RM2 (right side of the flow chart). The second active RM2 checks the minimum rank number MIN RN of the TP1, which is lower than its own RN, and forwards the TP1 also unchanged to the first RM1. The first RM1 recognizes its own “test packet” TP1 and checks the MIN RN in the rank number field RF. Because its RN1=1 is lower than the RN=2 of the RM2, the MIN RN has remained unchanged and RM1 remains active (MIN RN>OWN RN).

In another embodiment, the second RM2 sends a test packet TP2 (FIG. 2), which includes its source address e.g. “2” and its rank number MIN RN=RN2=2 (which also cad be its source address).

All other RMs in the ring check the test packet TP2, which was emitted from RM2 (right side of the flow chart).

All passive RMs and nodes in the ring forward this TP2 unchanged to the first active RM1 (right side of the flow chart).

The first active RM1 receives the TP2 and checks if its own rank number RN1=1 is lower than the received rank number OWN RN<MIN RN=RN2 in the RN field, replaces RN2 by RN1 and the forwards the altered TP2 to RM2.

RM2 receives and recognizes its own “test packet” TP2, checks if MIN RN is lower than its OWN RN and switches because of MIN RN<RN2 to the passive mode.

The result is that only RM1 with the lowest RN in the ring remains active.

If two or more RMs are configured in a ring, and if instead of the active node another node shall take over the role of an active RM, than the old RM is disabled by a management system and has no control function at all. Hence, the disabled RM associated to a node does not work as an active or a passive RM. Another possibility is to change the rank numbers of the RMs. Then the RM selection process has to be started.

Assuming that the RM1 is in the passive mode, and RM2 is in an active mode. RM1 sends it test packet with MIN TP=RN=1. All other RMs check this test packet, and Also, when RN2 is active, RN2 forwards the test packet TP1 unchanged because OWN RN>MIN RN. RM1 receives and evaluates its own test packet TP1, since MIN RN is not lower than its own RN1 (MIN RN=OWNRN; or empty) it switches to “active.”

Since the passive RM1 does not change MIN RN, both RMs are at first switched to an active mode. Then, according to the first and second embodiments, the RM2 (higher rank number) is switched to the passive mode and RM1 with the lowest rank number in the ring is selected to be the only remaining RM. By using this method a loop for data traffic is avoided.

The procedure and the flowchart becomes even more simplified if no differentiation between active and passive redundancy managers is necessary, and both the procedure and the corresponding flowchart is simplified. This flow chart is shown in FIG. 5. The redundancy manager with the lowest rank number RN—active or passive—shall become the only active redundancy manager.

In this case, the RM sending a test packet inserts its rank number OWN RN as MIN RN in the RN field, and all other passive or active RMs check if their rank number is lower than MIN RN (right side of the flow chart). If so, they replace MIN RN by their OWN RN. The RM, who initiated the test packet, checks if MIN RN<OWN RN and remains or switches to passive if the condition is fulfilled, otherwise it remains or switches to active.

A temporary loop may be created using this flow chart, if the process is started while RM1 is passive and RM2 is active. RM1 can switch to passive and unblock its ports for data traffic before RM1 switches to the active mode and blocks one of his ports. This temporary loop is usually not problematic.

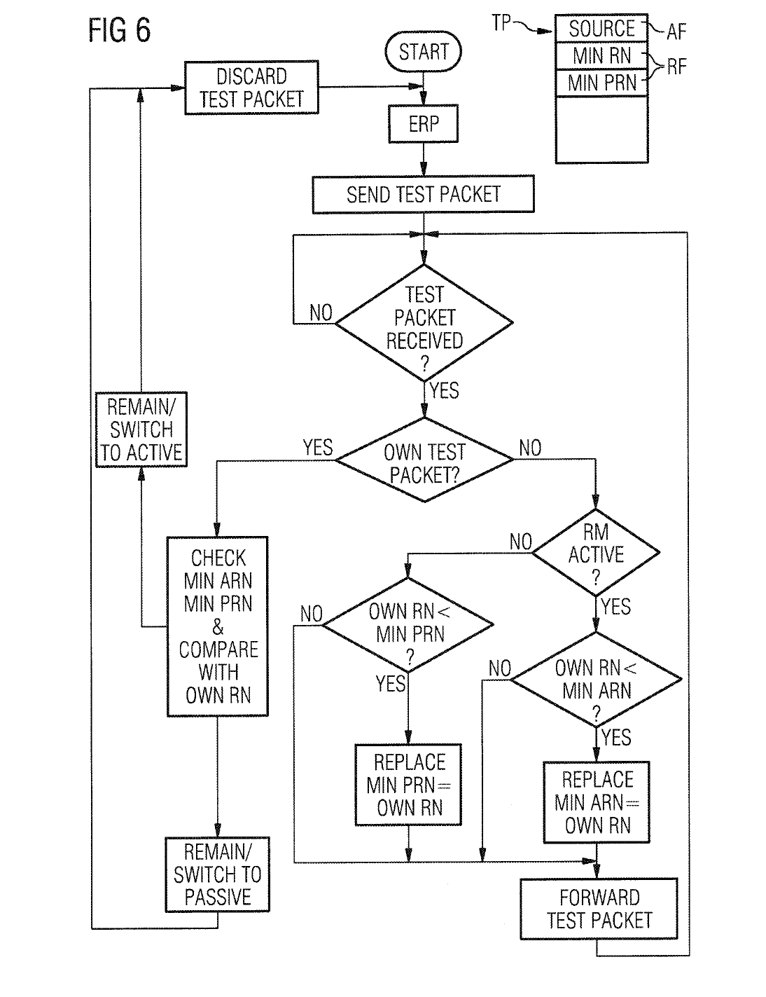

If the ring has many redundancy managers, it is advantageously to use two different RN fields for “active rank numbers” ARN and “passive rank numbers” PRN of active and passive redundancy managers. The flow chart is shown in FIG. 6.

A lowest active rank number (highest priority) MIN ARN of all active redundancy managers and a lowest active rank number MIN PRN of all passive redundancy managers in a ring is determined by transmitting and evaluating the test packet, and if an active or passive redundancy manager evaluates its own test packet, it has the information if another active or passive redundancy manager with a lower rank number (higher priority) is in the ring and unnecessary switching can be avoided, e.g. when all redundancy managers are in the passive mode (or many with lower rank numbers) and only one of them has to change to the active mode.

1. A method for ring management in an Ethernet network comprising
a plurality of redundancy managers in a ring, which can switch into an active or a passive mode, wherein
a rank number is assigned to each of the plurality of redundancy managers, each of the pluarlity of redundancy managers transmits test packets with at least one of a corresponding source address and rank number,
each of the other pluarlity of redundancy managers in the ring check the received test packets, add a corresponding rank numbers when required, and forward the test packets,
nodes without a redundancy manager function in the ring forward the test packet unchanged, and each of the plurality of redundancy managers, that receives its own test packet transmitted over the ring, evaluates the test packet, and switches from an active mode into a passive mode or remains in the passive mode, when its own rank number is higher than the rank number of another one of the plurality of redundancy managers inserted in the test packet.

2. The method according to claim 1,
wherein
an active one of the plurality of redundancy managers replaces the received minimum rank number with its own rank number in a rank number field of the received test packet, if its own rank number is less than a received rank number.

3. The method according to claim 2,
wherein
an active one of the plurality of redundancy managers, upon reception of its own test packet sent back over the ring, analyses its own test packet and switches into a passive mode, if the received rank number in its own test packet is lower than its own rank number, otherwise the active one of the plurality of redundancy managers remains active.

4. The method according to claim 2,
wherein
a passive one of the pluarlity of redundancy managers, upon reception of its own test packet sent back over the ring, analyses its own test packet and switches to an active mode if the received minimum rank number
is not lower than its own rank number or if the rank number field is empty, otherwise the passive one of the plurality of redundancy managers remains passive-.

5. The method according to claim 1,
wherein
one of the pluarity of redundancy managers, upon reception of a test packet, replaces a minimum rank number in a rank number field of the received test packet with its own rank number, if its own rank number is less than a received rank number.

6. The method according to claim 5,
wherein
one of the plurality of redundancy managers, upon reception of its own test packet sent back over the ring,
analyses its own test packet and switches into the passive mode or remains in the passive mode if its own rank number is higher than the received rank number, otherwise the one of the plurality of redundancy managers switches into or remains in the active mode.

7. The method according to claim 1,
wherein
an active rank number or a minimum active rank number of an active one of the pluarlity of redundancy managers is stored in a separate minimum active rank number field in the test packet, and
a passive rank Number or a minimum passive rank number of a passive one of the plurality of redundancy managers is stored in a minimum passive rank number field in the test packet.

8. The method according to claim 7,
wherein
a passive one of the pluarlity of redundancy managers replaces a received minimum passive rank number in a received test packet with its own passive rank number, when its passive rank number is lower than the passive minimum rank number,
an active one of the pluarlity of redundancy managers replaces a received minimum active rank number in a received test packet with its own active rank number, when its own active rank number is lower than the active minimum rank number, and
the passive one of the plurality of redundancy managers, upon reception of its own test packet sent back over the ring, analyses its own test packet and switches to the active mode if the received minimum passive rank number and the received minimum active rank number inserted in its own test packet are not lower than its own rank numbers, and
the active one of the plurality of redundancy managers, upon reception of its own test packet sent back over the ring, analyses its own test packet and switches to the passive mode if the received active minimum rank number inserted in its own test packet is lower than its own active rank number.

9. The method according to claim 1,
wherein
the one of the pluarlity of redundancy managers rank numbers are changed or the active one of the plurality of redundancy managers is disabled by a management system to change from the active one of the pluarity of redundancy managers to another active one of the pluarity of redundancy managers.
